(19) United States
(12) Patent Application Publication
(10) Pub. No.: US 2023/0102639 A1
(43) Pub. Date: Mar. 30, 2023

(54) Electronic Devices with Diffractive Coatings

(71) Applicant: Apple Inc., Cupertino, CA (US)

(72) Inventor: James R. Wilson, Saratoga, CA (US)

(21) Appl. No.: 17/886,363

(22) Filed: Aug. 11, 2022

Related U.S. Application Data
(60) Provisional application No. 63/248,177, filed on Sep. 24, 2021.

(51) Int. Cl. G02B 5/18

(52) U.S. Cl. CPC G02B 5/1842

(57) ABSTRACT

An electronic device may include a housing and a display mounted to the housing. The housing may have a rear wall, a front wall that forms a display cover layer, and sidewalls. A coating may be formed on a portion of the housing. The coating may include a diffractive layer having a textured surface that diffracts incoming light to form at least part of a spectral rainbow on an outer surface of the housing. The textured surface may have pits and bumps in any suitable shape and pattern. The coating may include a thin-film interference layer that increases an intensity of the spectral rainbow. The thin-film interference layer may be interposed between an ink layer and the diffractive layer. The diffractive layer may be a reflective diffractive layer that reflects ambient light or a transmissive diffractive layer that transmits light from a light source in the electronic device.

This application claims the benefit of provisional patent application No. 63/248,177, filed Sep. 24, 2021, which is hereby incorporated by reference herein in its entirety.

### FIELD

This relates generally to electronic devices and, more particularly, to electronic devices with diffractive coatings.

### BACKGROUND

Electronic devices such as cellular telephones, computers, watches, and other devices may contain glass structures. For example, electronic devices may have displays in which an array of pixels is covered with a transparent layer of glass. In some devices, a rear housing wall may be formed by a layer of glass. A decorative layer may be applied to the layer of glass to help improve the appearance of the rear housing wall or may be applied to an inactive portion of the layer of glass that covers the display.

It may be desirable to improve the outward appearance of a display cover layer or housing wall.

### SUMMARY

An electronic device may have a housing to which a display is mounted. The housing may be formed from housing structures that surround an interior region in the electronic device. Electrical components may be mounted in the electronic device interior.

The housing may have a rear wall, a front wall that forms a display cover layer, and sidewalls. A diffractive coating may be formed on a portion of the housing. The diffractive coating may include a diffractive layer having a textured surface that diffracts incoming light to form at least part of a spectral pattern such as a rainbow on an outer surface of the housing. The textured surface may have pits and bumps in any suitable shape and pattern. The pits and bumps may be shaped in the form of a logo or other suitable shape so that the resulting spectral rainbow is also imparted with the desired shape.

The coating may include a thin-film interference layer that increases an intensity of the spectral rainbow. The thin-film interference layer may be formed using physical vapor deposition and may be interposed between an ink layer and the diffractive layer. The diffractive layer may be a reflective diffractive layer that reflects ambient light or a transmissive diffractive layer that transmits light from a light source in the electronic device.

### BRIEF DESCRIPTION OF THE DRAWINGS

FIG. 1 is a perspective view of an illustrative electronic device in accordance with an embodiment.

FIG. 2 is a cross-sectional side view of an illustrative electronic device having one or more transparent layers forming housing walls in accordance with an embodiment.

FIG. 3 is a cross-sectional side view of a reflective diffractive coating on a transparent layer in accordance with an embodiment.

FIG. 4 is a cross-sectional side view of a transmissive diffractive coating on a transparent layer in accordance with an embodiment.

FIG. 5 is a cross-sectional side view of an illustrative thin-film interference layer in accordance with an embodiment.

FIG. 6 is a cross-sectional side view of a textured master glass layer in accordance with an embodiment.

FIG. 7 is a cross-sectional side view of a stamping structure that may be produced by a master glass layer of the type shown in FIG. 6 in accordance with an embodiment.

FIG. 8 is a cross-sectional side view of a stamping structure being applied to a layer in accordance with an embodiment.

FIG. 9 is a cross-sectional side view of a layer with a textured surface in accordance with an embodiment.

FIGS. 10, 11, and 12 are cross-sectional side views of a layer having a textured surface with different geometries in accordance with an embodiment.

FIG. 13 is a top view of a layer having a textured surface with a horizontal pattern in accordance with an embodiment.

FIG. 14 is a top view of a layer having a textured surface with a vertical pattern in accordance with an embodiment.

FIG. 15 is a top view of a layer having a textured surface with a circular pattern in accordance with an embodiment.

FIG. 16 is a top view of a layer having a textured surface with a heart-shaped pattern in accordance with an embodiment.

### DETAILED DESCRIPTION

Electronic devices such as cellular telephones often include transparent members such as display cover layers, glass housing members, and/or other transparent members such as clear polymer layers. These layers may be coated with materials such as ink. The ink may be opaque to hide internal device components from view, but may not always have a desired appearance. The appearance of transparent layers in an electronic device can be altered by depositing layers such as diffractive coating layers onto the transparent layers. A diffractive coating may include a textured surface (e.g., a layer of film, glass, or other material that has a textured surface). The textured surface may have a pattern of small and closely spaced protrusions and recesses (e.g., bumps and pits) that diffract incident light in multiple directions, causing constructive and destructive interference in the diffracted light and creating a spectral pattern such as a rainbow that is viewable on an outer surface of the device. Optional additional layers may be applied to the diffractive coating, such as thin-film interference layers and ink layers. In these coatings, thin-film interference layers may be used to increase an intensity of the spectral rainbow. The pattern of pits and bumps on the textured surface may have different geometries, orientations, shapes, and spacings to achieve the desired optical effect from the diffractive coating.

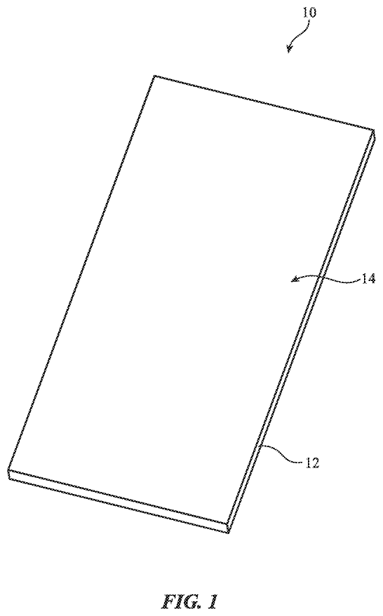

An illustrative electronic device of the type that may have one or more diffractive coatings is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, an accessory (e.g., earbuds, a remote control, a wireless trackpad, etc.), or other electronic equipment. In the illustrative configuration of FIG. 1, device 10 is a portable device such as a cellular telephone, media player, tablet computer, or other portable computing device. Other configurations may be used for device 10 if desired. The example of FIG. 1 is merely illustrative.

In the example of FIG. 1, device 10 includes a display such as display 14 mounted in housing 12. Housing 12, which may sometimes be referred to as an enclosure or case, may be formed of plastic, glass, ceramics, fiber composites, metal (e.g., stainless steel, aluminum, titanium, gold, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of pixels formed from liquid crystal display (LCD) components, an array of electrophoretic pixels, an array of plasma pixels, an array of organic light-emitting diode pixels or other light-emitting diodes, an array of electrowetting pixels, or pixels based on other display technologies.

Display 14 may include one or more layers of glass. For example, the outermost layer of display 14, which may sometimes be referred to as a display cover layer, may be formed from a hard transparent material such as glass to help protect display 14 from damage. Other portions of device 10 such as portions of housing 12 and/or other structures may also be formed from glass. For example, walls in housing 12 such as a rear housing wall may be formed from glass.

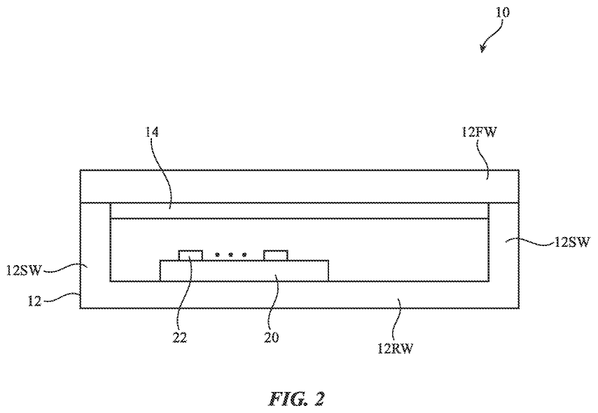

A cross-sectional side view of device 10 is shown in FIG. 2. As shown in FIG. 2, device 10 may have an interior in which electrical components 22 are housed. Electrical components 22 may include integrated circuits, sensors, and other circuitry. As examples, electrical components 22 may form wireless communications circuitry, wireless charging circuitry, processing circuitry, and/or display circuitry, as examples. In general, any desired circuitry may be formed in device 10. Components 22 may be mounted on one or more printed circuits such as printed circuit 20.

As shown in FIG. 2, device 10 may have opposing front and rear faces. Display 14 may be formed on the front face of device 10 and may be covered by a front housing wall 12FW. Housing 12 may have a rear housing wall 12RW on the opposing rear face of device 10. Portions of housing 12 may also form sidewalls 12SW for device 10. These sidewall portions of housing 12 may be formed from a material such metal, may be formed from a glass substrate layer, may be formed from the same layer as rear housing wall 12RW, and/or may be formed from the same layer as front housing wall 12FW, as examples. Sidewalls 12SW may be planar, may have curved profiles, or may have other suitable shapes.

Display 14 may be covered by a display cover layer. As shown in FIG. 2, for example, front wall 12FW of housing 12 may form a display cover layer for display 14. Front wall 12FW (sometimes referred to as display cover layer 12FW) may be a layer of glass, sapphire, clear polymer, or other transparent layer. Display 14 may include display layers that form an array of pixels that present images for a user on the front face of device 10. Display 14 may be a liquid crystal display, an organic light-emitting diode display, or other suitable display. During operation, display 14 may present images that are viewable through front housing wall 12FW.

Some or all of housing 12 such as rear housing wall 12RW and/or sidewalls 12SW may be formed from transparent structures such as a layer of glass, sapphire, clear polymer, or other transparent layer. The thickness of rear housing wall 12RW may be 0.2-5 mm, at least 0.05 mm, at least 0.1 mm, at least 0.2 mm, at least 0.5 mm, at least 0.75 mm, less than 1 mm, less than 2 mm, or other suitable thickness. If desired, a metal plate or other strengthening structures may be laminated to portions of the inner surface of rear housing wall 12RW and/or sidewalls 12SW to enhance strength.

Inactive border areas in front housing wall 12FW and portions of other transparent structures in device 10 such as some or all of rear housing wall 12RW and/or sidewalls 12SW may be covered with coatings and other structures. In some arrangements, a coating may be used primarily to block light (e.g., to hide internal device structures from view). For example, a coating may be formed on the inner surface of rear housing wall 12RW to hide internal components from view. In other arrangements, a patterned coating may be used to form text, logos, trim, and/or other visible patterns. Coatings that are not patterned and that coat all of rear housing wall 12RW and/or sidewalls 12SW may also be used to block internal structures from view and/or to provide device 10 with a desired appearance. Patterned coatings may create visible elements and may also block internal structures from view.

Coatings for transparent structures in device 10 may be black or other neutral colors or may have non-black (non-neutral) colors (e.g., blue, red, yellow, gold, rose gold, red-violet, pink, rainbow, etc.). In some configurations, some or all of the coatings for glass structures in device 10 may be shiny (e.g., exhibiting a mirror-like reflective surface with a reflectance of at least 50%, at less 80%, at least 95%, less than 99.99%, or other suitable reflectance).

Coatings on rear housing wall 12RW and/or other glass structures in device 10 may be formed from metals, semiconductors, and/or dielectrics. Dielectric materials for the coatings may include organic materials such as polymer layers and/or inorganic materials such as oxide layers, nitride layers, and/or other inorganic dielectric materials. In arrangements in which a shiny surface is desired, a metal coating with a high reflectivity or a thin-film interference filter with dielectric layers (e.g., a stack of dielectric layers of alternating higher and lower refractive index values) may be configured to serve as a mirror coating (reflective coating). Ink coatings may also be incorporated onto the glass structures, if desired.

If desired, a transparent layer forming rear housing wall 12RW, sidewalls 12SW, and/or front wall 12FW may be coated with a diffractive coating. The diffractive coating may include a layer having a textured surface (e.g., a layer of film, glass, or other material having a textured surface). The textured surface may have a pattern of small and closely spaced bumps and pits that diffract incident light in multiple directions, causing constructive and destructive interference in the diffracted light and creating a spectral pattern such as a rainbow effect on an outer surface of the device.

FIG. 3 is a cross-sectional side view of an illustrative transparent layer 24, such as a glass layer, sapphire layer, clear polymer layer, or other suitable transparent layer that is coated with a diffractive coating such as diffractive coating 16. As an example, transparent layer 24 may form one or more of rear housing wall 12RW, sidewalls 12SW, or front housing wall 12FW of FIG. 2. In general, coating 16 may include one or more diffractive layers such as diffractive layer 30 and optionally one or more additional layers such as ink layers, film layers, dielectric layers, thin-film interference layers, reflective layers, adhesive layers, and/or other suitable layers. If desired, coating 16 may be formed on non-transparent (e.g., opaque) layers in device 10 such as metal housing structures. Arrangements in which coating 16 is formed on a transparent layer are sometimes described herein as an illustrative example.

In the example of FIG. 3, coating 16 includes ink layer 34, mirror layer 32, diffractive layer 30, polymer layer 28, and adhesive layer 26. Ink layer 34 may be formed from polymer containing colorant such as dye, pigment, and/or flakes (e.g., for a speckled effect). The colorant may have a neutral color such as white, gray, or black, may have a non-neutral color such as red, blue, green, yellow, gold, or may have another suitable color. If desired, ink layer 34 may be omitted from coating 16.

Mirror layer 32 may be a metal coating (e.g., a layer of aluminum, titanium, or other metal), a thin-film interference filter, or other reflective layer. For example, mirror layer 32 (sometimes referred to as reflective layer 32, thin-film interference layer 32, thin-film interference filter 32, thin-film stack 32, etc.) may include multiple thin-film layers formed in a stack. Thin-film stacks such as these may form thin-film interference filters (sometimes referred to as dichroic filters or dichroic layers). The optical properties of each of the layers in a thin-film stack (e.g., the index of refraction of each layer) and the thickness of each layer may be selected to provide the thin-film interference filter with desired characteristics (e.g., a desired light transmission spectrum, a desired light reflection spectrum, a desired light absorption spectrum). A thin-film stack may, as an example, be configured to reflect light of a particular color or to exhibit a color-neutral behavior (e.g., to serve as a neutral-color partially reflective mirror). Layer 32 may be formed from dielectric materials such as inorganic dielectric layers deposited with physical vapor deposition techniques and may therefore sometimes be referred to as a physical vapor deposition layer, physical vapor deposition coating, or physical vapor deposition stack. Other techniques for forming layer 32 may be used, if desired. Layer 32 may be configured to form a dielectric mirror that reflects a relatively large amount of light (e.g., 10-20% reflectivity, 30% reflectivity, 50% reflectivity, or a reflectivity of at least 5%, at least 15%, at least 20%, less than 85%, less than 60%, less than 50%, less than 35%, or other suitable value).

Diffractive layer 30 may be a layer of film (e.g., a resin such as an ultraviolet light cured resin or other polymer) or a layer of glass having a textured surface 30T. Textured surface 30T may include a pattern of protrusions and recesses such as bumps 50 and pits 56 that effectively form a diffraction grating. Textured surface 30T may be formed using a stamping structure that imparts the desired pattern of pits and bumps into a film or may be formed from a patterned surface of a glass layer. Textured surface 30T may include pits and bumps that have semi-spherical shapes, semi-cylindrical shapes, flat shapes (e.g., flat shelf shapes), triangular shapes (e.g., to form a blazed grating), and/or other suitable shapes. The pattern of pits and bumps may be evenly spaced, unevenly spaced, randomly distributed, or may have other suitable patterns. The height of bumps 50 of textured surface 30T relative to pits 56 of textured surface 30T may be between 0.1 micron and 1 micron, between 1 micron and 5 microns, between 5 microns and 10 microns, greater than 10 microns, less than 10 microns, or other suitable height.

Polymer layer 28 may be formed from polycarbonate or other suitable polymer and may be interposed between diffractive layer 30 and adhesive layer 26. Adhesive layer 26 may be used to adhere the remaining layers in coating 16 to transparent layer 24.

As shown in FIG. 3, a user 42 may view transparent layer 24 of device 10 in direction 44. As light 46 (e.g., ambient light in the user's environment) passes through transparent layer 24 and coating 16, the light strikes textured surface 30T of diffractive layer 30 and is reflected by layer 32. The pits and bumps of textured surface 30T may diffract reflected light 46R in multiple directions. The constructive and destructive interference between reflected light 46R may create some or all of a spectral rainbow such as red, orange, yellow, green, blue, indigo, and/or violet light (or any other suitable spectral pattern). User 42 may view the rainbow colors of light 46R on layer 24 (e.g., an outer surface of device 10). The reflectivity of layer 32 may increase the intensity of reflected light 46R and the intensity of the spectral rainbow that is viewable on the outer surface of device 10. This is merely illustrative, however. If desired, filter layer 32 may be omitted.

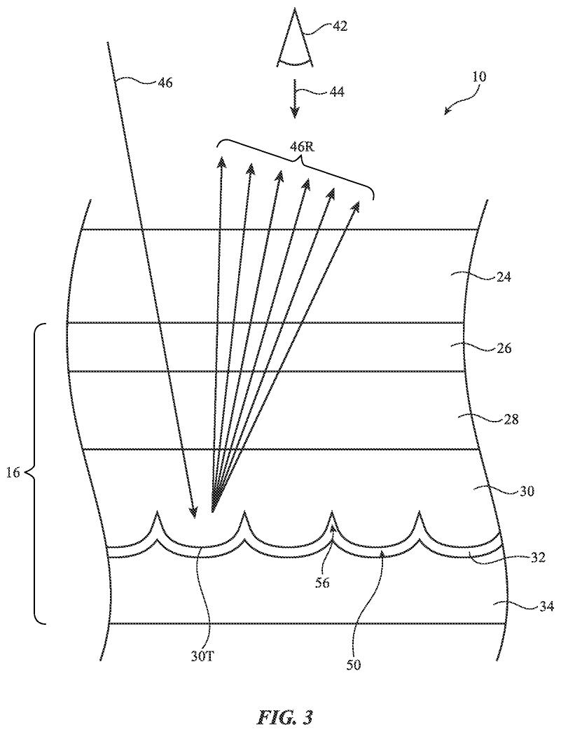

The arrangement of FIG. 3 in which diffractive coating 16 is a reflective diffractive coating is merely illustrative. If desired, diffractive coating 16 may be a transmissive diffractive coating. This type of arrangement is illustrated in FIG. 4.

As shown in FIG. 4, user 42 may view transparent layer 24 of device 10 in direction 44. Diffractive coating 16 may be formed on transparent layer 24. For transmissive diffraction effects, opaque layers such as ink layers may be omitted from coating 16, if desired. Coating 16 may be backlit by a light source in device 10 such as light source 48. Light source 48 may include one or more light-emitting diodes or other light sources. Light source 48 may emit light 46 toward coating 16. Light 46 may pass through layer 32 and may strike textured surface 30T of diffractive layer 30. The pits and bumps of textured surface 30T may diffract transmitted light 46T in multiple directions. The constructive and destructive interference between transmitted light 46T may create some or all of a spectral rainbow such as red, orange, yellow, green, blue, indigo, and/or violet light (or any other suitable spectral pattern). User 42 may view the rainbow colors of light 46R on layer 24 (e.g., an outer surface of device 10). The reflectivity of layer 32 may increase the intensity of transmitted light 46T and the intensity of the spectral rainbow that is viewable on the outer surface of device 10. This is merely illustrative, however. If desired, layer 32 may be omitted.

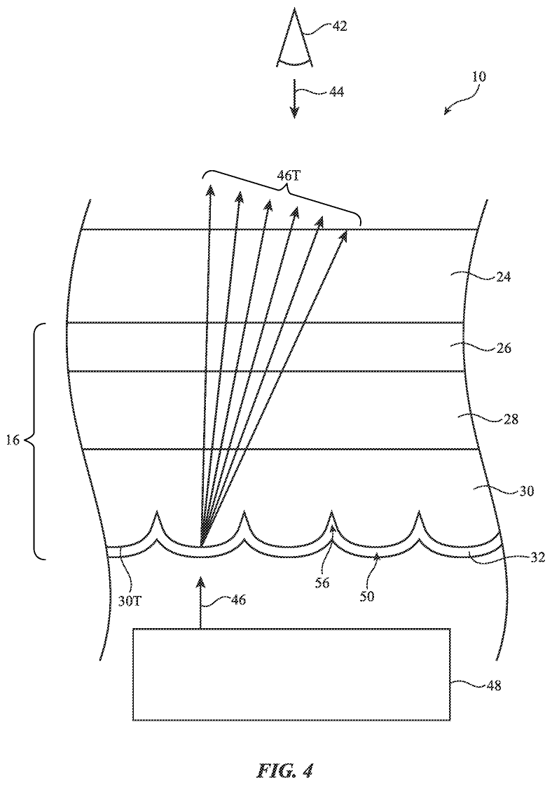

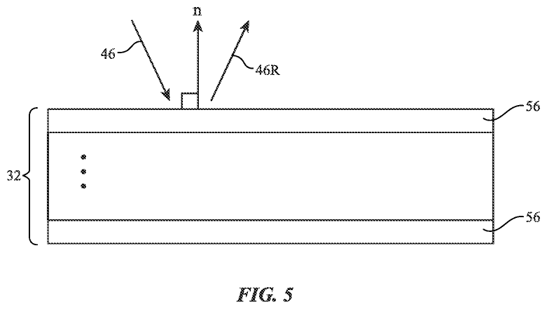

FIG. 5 is a cross-sectional side view of an illustrative thin-film stack configured to form a thin-film interference filter. Thin-film interference filter 32 of FIG. 5 may be used to form mirror layer 32 of FIGS. 3 and 4, if desired. The thin-film stack 32 of FIG. 5 has multiple layers 56. Layers 56 may have thicknesses of 0.01-1 micron, at least 0.05 microns, at least 0.1 microns, at least 0.15 microns, less than 1.5 microns, less than 1 micron, etc. Layers 56 may be inorganic dielectric layers (e.g., oxides such as silicon oxide, niobium oxide, titanium oxide, tantalum oxide, zirconium oxide, magnesium oxide, etc., nitrides such as silicon nitride, oxynitrides, and/or other inorganic dielectric materials). Organic dielectric layers (e.g., clear polymer layers) and/or other materials (thin metal films, semiconductor layers, etc.) may also be included in the thin-film stack, if desired.

In the example of FIG. 5, the thin-film stack formed from layers 56 forms thin-film interference filter 32. Filter 32 may be formed from dielectric materials such as inorganic dielectric layers deposited with physical vapor deposition techniques and may therefore sometimes be referred to as a physical vapor deposition layer, physical vapor deposition coating, or physical vapor deposition stack. Other techniques for forming filter 32 may be used, if desired.

Filter 32 may be configured to exhibit high reflectivity (e.g., filter 32 may be configured to form a dielectric mirror that reflects a relatively large amount of light 46R relative to incident light 46, may be configured to exhibit low reflectivity, may be configured to form a colored (tinted) layer (e.g., by reflecting one or more selected colors of light such as when configuring filter 32 to serve as a bandpass filter, band-stop filter, low pass filter, or high pass filter), and/or may be configured to from a light-blocking layer (e.g., by exhibiting a high opacity). Layers 56 may also be configured to adjust the optical properties (transmission, reflection, absorption) of filter 32 at multiple different incident angles (e.g., angles with respect to surface normal n for filter 32 that is associated with an incident angle of incoming light 46 and that is also associated with corresponding angle of view for a viewer viewing reflected light 46R).

The arrangement of FIG. 5 in which thin-film interference layer 32 is reflective is merely illustrative. If desired, thin-film interference layer 32 may be configured as a transmissive thin-film interference layer (e.g., for forming layer 32 in transmissive diffractive coating 16 of FIG. 4).

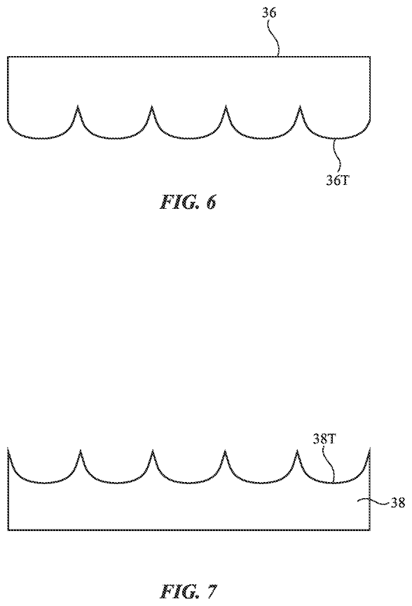

FIGS. 6, 7, 8, and 9 show illustrative layers that may be used during the process of forming a diffractive layer such as diffractive layer 30 of coating 16.

FIG. 6 is a cross-sectional side view of an illustrative layer of glass. Glass layer 36 may have a textured surface 36T. Textured surface 36T may have the desired pattern of pits and bumps in diffractive layer 30 (FIGS. 3 and 4). Glass layer 36 may serve as a master glass layer that is used to create stamping structures for stamping individual diffractive layers 30. For example, a stamping structure such as stamping structure 38 of FIG. 7 may be formed by depositing a film onto textured surface 36T of glass layer 36. When the film is cured, glass layer 36 may be removed, thereby leaving stamping structure 38 with textured surface 38T. Textured surface 38T may have an inverse of the pattern of textured surface 36T. This allows stamping structure 38 to be used to stamp the desired pattern of pits and bumps into layer 30, as shown in

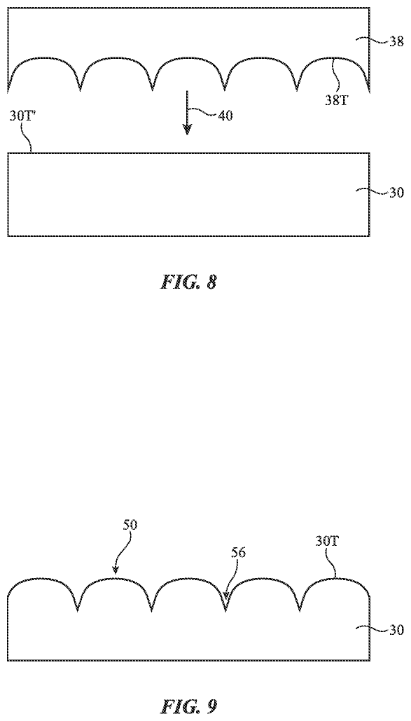

As shown in FIG. 8, layer 30 may initially have a smooth surface 30T′ without pits and bumps. Stamping structure 38 may pressed into layer 30 in direction 40, thereby bringing textured surface 38T into contact with film 30. This imparts a pattern into layer 30 that is an inverted version of the pattern of textured surface 38T, as shown in FIG. 9 (i.e., the pattern of textured surface 36T of master glass layer 36 will be imparted to layer 30).

As shown in FIG. 9, layer 30 may have textured surface 30T after being stamped by stamping structure 30 of FIG. 8. Textured surface 30T may have a pattern of pits and bumps (e.g., bumps 50 and pits 56) that matches that of master glass layer 36.

FIGS. 10, 11, and 12 show different illustrative geometries of pits and bumps that may be formed on textured surface 30T of layer 30. These are merely illustrative, however. If desired, textured surface 30T may have other surface geometries.

In the example of FIG. 10, textured surface 30T has pits and bumps with flat shapes (e.g., flat shelf shapes). Bumps 50 may have rectangular shapes and pits 56 may have rectangular shapes. The spacing between pits and bumps on textured surface 30T may be adjusted depending on the desired rainbow effect. For example, the spacing D1 between the center of one bump 50 and the center of an adjacent bump 50 may be selected based on the desired spread of the spectral pattern produced by diffractive layer 30. In general, a tighter spacing between bumps (e.g., a smaller dimension D1) will result in a more spread out rainbow (e.g., a larger space will be consumed by individual colors of the spectral rainbow), while a larger spacing between bumps (e.g., a larger dimension D1) will result in a tighter rainbow pattern (e.g., a smaller space will be consumed by individual colors of the spectral rainbow) and may also result in an appearance of one or more higher order rainbows. Spacing D1 may be 1.5 microns, between 1 micron and 2 microns, between 3 microns and 5 microns, between 4 microns and 12 microns, greater than 10 microns, less than 10 microns, etc.

In the example of FIG. 11, textured surface 30T has pits and bumps with round shapes. Bumps 50 have semi-circular cross-sectional shapes, and pits 56 also have semi-circular cross-sectional shapes. The spacing between bumps may be 1.5 microns, between 1 micron and 2 microns, between 3 microns and 5 microns, between 4 microns and 12 microns, greater than 10 microns, less than 10 microns, etc.

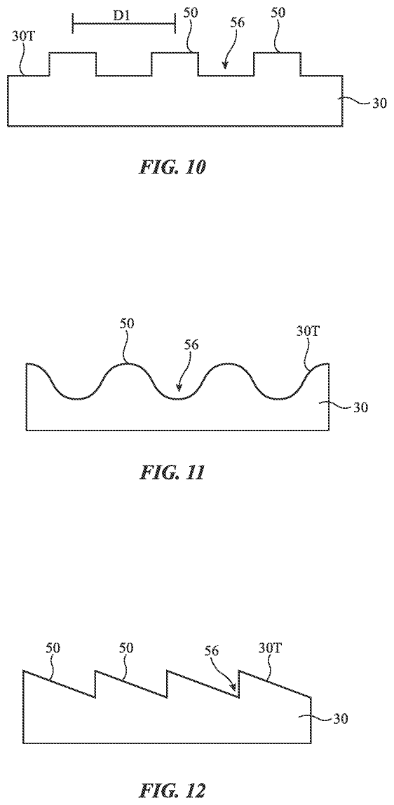

In the example of FIG. 12, textured surface 30T has pits and bumps with triangular shapes to form a blazed grating. Bumps 50 have triangular shapes, and pits 56 also have triangular shapes. The spacing between bumps may be 1.5 microns, between 1 micron and 2 microns, between 3 microns and 5 microns, between 4 microns and 12 microns, greater than 10 microns, less than 10 microns, etc.

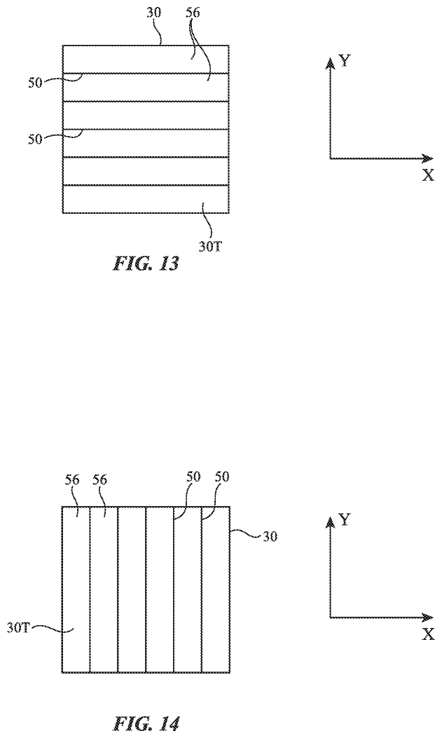

FIGS. 13, 14, 15, and 16 are top views of textured surface 30T of diffractive layer 30 showing different patterns that may be created with the pits and bumps of textured surface 30T. Different patterns of pits and bumps may be used to create different shapes in the spectral rainbow created by coating 16.

In the example of FIG. 13, pits 56 and bumps 50 extend parallel to one another in a horizontal direction (e.g., parallel to the x-axis of FIG. 13). This may be used to create a spectral rainbow that spreads out along the y-axis of FIG. 13.

In the example of FIG. 14, pits 56 and bumps 50 extend parallel to one another in a vertical direction (e.g., parallel to the y-axis of FIG. 13). This may be used to create a spectral rainbow that spreads out along the x-axis of FIG. 14.

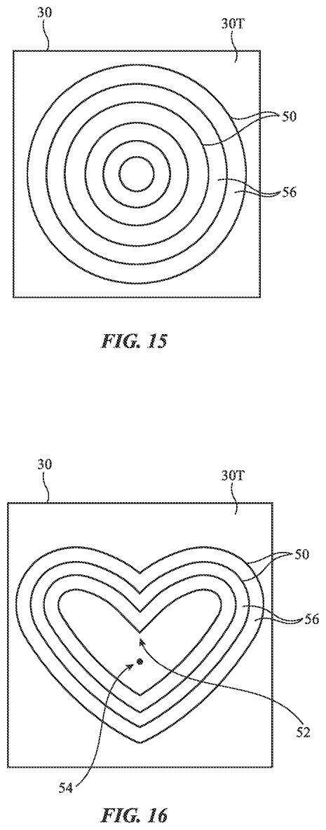

In the example of FIG. 15, pits 56 and bumps 50 form concentric circles This may be used to create a spectral rainbow that spreads out radially from the center of textured surface 30T.

In the example of FIG. 16, pits 56 and bumps 50 are arranged to form an irregular shape such as a heart. This is merely illustrative. In general pits 56 and bumps 50 may be used to form any desired shape (e.g., a logo, a symbol, a letter, an emoji, etc.). This may be used to create a spectral rainbow that spreads out in different directions depending on the shape of the pattern. To create the desired shape, pits 56 and bumps 50 may have portions that follow straight paths, curved paths, angled paths, zig-zag paths, non-straight paths, and/or other suitable path shapes. Each pit 56 and bump 50 may be equally spaced from an adjacent pit 56 and bump 50, or some variation of spacing may be used to account for corners in the desired shape such as corner 52. For example, pits 56 and bumps 50 may be placed proportionally to center 54 to avoid undesired visual artifacts (e.g., lines or other disruptions) that may otherwise be caused by corner 52 in the spectral rainbow produced by layer 30.

The foregoing is merely illustrative and various modifications can be made to the described embodiments. The foregoing embodiments may be implemented individually or in any combination.

What is claimed is:

1. An electronic device having opposing front and rear faces, the electronic device comprising:
a display on the front face;
a transparent layer that forms a housing wall on the rear face; and
a coating on the transparent layer, wherein the coating comprises a diffractive layer that diffracts light to create a spectral pattern that is viewable on the rear face.

2. The electronic device defined in claim 1 wherein the transparent layer comprises glass.

3. The electronic device defined in claim 1 wherein the coating comprises a thin-film interference layer on the diffractive layer.

4. The electronic device defined in claim 3 wherein the thin-film interference layer increases an intensity of the spectral pattern.

5. The electronic device defined in claim 3 wherein the coating comprises an ink layer, wherein the thin-film interference layer is interposed between the ink layer and the diffractive layer.

6. The electronic device defined in claim 5 wherein the ink layer comprises a color selected from the group consisting of: white, black, and gold.

7. The electronic device defined in claim 1 wherein the spectral pattern comprises at least part of a spectral rainbow and wherein the diffractive layer comprises a material selected from the group consisting of: polymer and glass.

8. The electronic device defined in claim 1 wherein the diffractive layer comprises a textured surface having pits and bumps.

9. The electronic device defined in claim 8 wherein the pits and bumps have a shape selected from the group consisting of: a semi-circular shape, a flat shelf shape, and a triangular shape.

10. The electronic device defined in claim 8 wherein the pits and bumps have portions that follow a curved path.

11. An electronic device, comprising:
a housing having a housing wall; and
a coating on the housing wall, the coating comprising:
a diffractive layer having a textured surface that diffracts incoming light to form at least part of a spectral rainbow; and
a thin-film interference layer on the diffractive layer that increases an intensity of the spectral rainbow.

12. The electronic device defined in claim 11 wherein the housing wall comprises a glass layer, the electronic device further comprising a display mounted to the housing.

13. The electronic device defined in claim 11 wherein the textured surface of the diffractive layer has a pattern of pits and bumps that form a logo shape.

14. The electronic device defined in claim 13 wherein the pits and bumps have a shape selected from the group consisting of: a semi-circular shape, a flat shelf shape, and a triangular shape.

15. The electronic device defined in claim 11 wherein the coating comprises an ink layer and wherein the thin-film interference layer is interposed between the ink layer and the diffractive layer.

16. An electronic device, comprising:
a housing having an outer surface;
a diffractive coating on the housing; and
a light source that emits light toward the diffractive coating, wherein the diffractive coating diffracts the light to form at least part of a spectral rainbow on the outer surface.

17. The electronic device defined in claim 16 wherein the diffractive coating comprises a diffractive layer with a textured surface having pits and bumps.

18. The electronic device defined in claim 17 wherein the diffractive coating comprises a thin-film interference layer on the diffractive layer, wherein the thin-film interference layer increases an intensity of the spectral rainbow.

19. The electronic device defined in claim 18 wherein the diffractive layer comprises polymer.

20. The electronic device defined in claim 16 wherein the housing comprises a glass layer and wherein the diffractive coating is formed on the glass layer.
